(19) United States
(12) Patent Application Publication
(10) Pub. No.: US 2015/0334305 A1
(43) Pub. Date: Nov. 19, 2015

(54) DISPLAYING METHOD AND ELECTRONIC DEVICE

(71) Applicant: HTC Corporation, Taoyuan County (TW)

(72) Inventors: Pai-Chang Yeh, Taoyuan County (TW); Peng-Jr Weng, Taoyuan County (TW); Jui-Chieh Wu, Taoyuan County (TW); Chen-Wen Wu, Taoyuan County (TW)

(73) Assignee: HTC Corporation, Taoyuan County (TW)

(21) Appl. No.: 14/275,899

(22) Filed: May 13, 2014

(51) Int. Cl. H04N 5/232

(52) U.S. Cl. CPC H04N 5/23293; H04N 5/23212

(57) ABSTRACT

A displaying method for an electronic device is provided. The electronic device comprises a storage device storing at least a photo group and a sharpness look-up table. The photo group includes a plurality of photos of an object successively captured in different focuses and the sharpness look-up table records sharpness information of each of the photos. The displaying method comprises displaying a cover photo of the photo group and receiving a selecting signal indicating a position on the cover photo. According to the position, the sharpness information of each photo in the sharpness look-up table is checked to determine a photo to be displayed, wherein the sharpness information of the determined photo shows a sharpness score at the position of the determined photo is the maximum among the sharpness scores at the positions of the photos in the photo group. The determined photo of the object is displayed.

### BACKGROUND OF THE INVENTION

1. Field of Invention

The present invention relates to a displaying method and an electronic device. More particularly, the present invention relates to a displaying method and an electronic device for displaying photos successively captured in different focuses.

2. Description of Related Art

In early days, cameras adopting soft films are used for taking pictures and recording static pictures, however, the images cannot be viewed immediately after being shot, and furthermore, additional time and money must be spent on developing the films into photos. Therefore, in the coming digital era, the cameras in early days have been gradually replaced by digital cameras, which are capable of viewing images in real time, and even directly transmitting the images to the connected printing machine, so as to develop into photos.

While the camera is operated to capture a photo/image of an object/scene, the user either manually adjusts the focus of the optical lenses or adopts the auto-focus function to adjust the focus of the optical lenses. However, by applying either one of the focal adjustment methods mentioned above, it is highly possible that some points on the photo in which the user is actually interested are out of focus. Thus, sometimes, it is difficult for the user to take a photo with which user is satisfied at every point.

### SUMMARY OF THE INVENTION

The present invention is to provide a displaying method capable of displaying one of the successively captured photos which possesses the best sharpness at the point of interest indicated by the user in the photo.

The invention further provides an electronic device with more powerful functions on displaying single photo or the photos captured in the multi-focus mode.

To achieve these and other advantages and in accordance with the purpose of the invention, as embodied and broadly described herein, the invention provides a displaying method for an electronic device. The electronic device comprises a storage device storing at least a photo group and a sharpness look-up table. The photo group includes a plurality of photos of an object successively captured in different focuses and the sharpness look-up table records sharpness information of each of the photos. The displaying method comprising displaying a cover photo of the photo group and receiving a selecting signal indicating a position on the cover photo. According to the position, the sharpness information of each of the photos in the sharpness look-up table is checked to determine a photo to be displayed from the photo group, wherein the sharpness information of the determined photo reveals that a sharpness score at the position of the determined photo is the maximum among the sharpness scores at the positions of the photos in the photo group. The determined photo of the object is displayed.

According to one embodiment of the present invention, for each of the photos, the photo is divided into a plurality of sub-images respectively corresponding to the sharpness scores and, in the sharpness look-up table, the sharpness information of each of the photos includes the sharpness scores respectively with the corresponding the sub-images.

According to one embodiment of the present invention, the step of checking the sharpness information of each of the photos comprises, for each of the photos, determining which of the sub-images the position belongs to and comparing the sharpness scores of the determined sub-images of the photos with each other to determine one of the photos to be displayed, wherein the determined photo has the determined sub-image with a maximum sharpness score.

According to one embodiment of the present invention, for each of the photos, the photo is divided into a plurality of sub-images respectively corresponding to the sharpness scores and, in the sharpness look-up table, the sharpness information of each of the photos includes a maximum sharpness score among the sharpness scores of the sub-images and coordinate information of the sub-image having the maximum sharpness score.

According to one embodiment of the present invention, the step of checking the sharpness information of each of the photos comprises, according to the coordinate information of each of the photos in the sharpness look-up table, determining one of the photos to be displayed, wherein the coordinate information in the sharpness information of the determined photo is closely correlated to the position.

According to one embodiment of the present invention, in the sharpness look-up table, the sharpness information of each of the photos includes a plurality of coordinate sets respectively corresponding to a plurality of sharpness contours of the photo and the sharpness scores respectively corresponding to the coordinate sets.

According to one embodiment of the present invention, the step of checking the sharpness information of each of the photos comprises, for each of the photo, determining which of the sharpness contours of the photo the position belongs to and comparing the sharpness scores of the determined sharpness contours respectively corresponding to the photos with each other to determine one of the photos to be displayed, wherein the determined photo has the determined sharpness contours with a maximum sharpness score.

According to one embodiment of the present invention, the cover photo of the photo group is random picked.

According to one embodiment of the present invention, before the step of displaying the cover photo of the photo group, the photos successively captured in different focuses are analyzed to extract the sharpness information of each of the photos so as to build up the sharpness look-up table and the sharpness look-up table is stored in the storage device with the photo group.

The invention also provides a displaying method for an electronic device, wherein the electronic device comprises a storage device storing at least a photo group, and the photo group includes a plurality of photos of an object successively captured in different focuses. The displaying method comprising receiving a displaying signal indicating a focus value and displaying a photo from the photo group, wherein the displayed photo is captured in the indicated focus value.

According to one embodiment of the present invention, the electronic device displays a cover photo of the photo group with a focus scrolling tool having a scrolling bar and a trough which the scrolling bar moves along. The step of receiving the displaying signal comprises receiving the displaying signal through the focus scrolling tool for dragging the scrolling bar along the trough so as to indicate the focus value and upon the displaying signal, finding the photo in the photo group is captured in the focus value.

The invention further provides an electronic device comprising a storage device, a display device and a processing unit. The storage device stores at least a photo group and a sharpness look-up table, wherein the photo group includes a plurality of photos of an object successively captured in different focuses, and the sharpness look-up table records sharpness information of each of the photos. The processing unit controls the display device to display a cover photo of the photo group, receives a selecting signal indicating a position on the cover photo, checks the sharpness information of each of the photos in the sharpness look-up table according to the position to determine a photo to be displayed from the photo group and controls the display device to display the determined photo of the object. The sharpness information of the determined photo reveals that a sharpness score at the position of the determined photo is the maximum among the sharpness scores at the positions of the photos in the photo group.

According to one embodiment of the present invention, for each of the photos, the photo is divided into a plurality of sub-images respectively corresponding to the sharpness scores and, in the sharpness look-up table, the sharpness information of each of the photos includes the sharpness scores respectively with the corresponding the sub-images.

According to one embodiment of the present invention, the processing unit checking the sharpness information of each of the photos further comprises, for each of the photos, determining which of the sub-images the position belongs to and comparing the sharpness scores of the determined sub-images of the photos with each other to determine one of the photos to be displayed, wherein the determined photo has the determined sub-image with a maximum sharpness score.

According to one embodiment of the present invention, for each of the photos, the photo is divided into a plurality of sub-images respectively corresponding to the sharpness scores and, in the sharpness look-up table, the sharpness information of each of the photos includes a maximum sharpness score among the sharpness scores of the sub-images and coordinate information of the sub-image having the maximum sharpness score.

According to one embodiment of the present invention, the processing unit checking the sharpness information of each of the photos further comprises, according to the coordinate information of each of the photos in the sharpness look-up table, determining one of the photos to be displayed, wherein the coordinate information in the sharpness information of the determined photo is closely correlated to the position.

According to one embodiment of the present invention, in the sharpness look-up table, the sharpness information of each of the photos includes a plurality of coordinate sets respectively corresponding to a plurality of sharpness contours of the photo and the sharpness scores respectively corresponding to the coordinate sets.

According to one embodiment of the present invention, the processing unit checking the sharpness information of each of the photos further comprises, for each of the photo, determining which of the sharpness contours of the photo the position belongs to and comparing the sharpness scores of the determined sharpness contours respectively corresponding to the photos with each other to determine one of the photos to be displayed, wherein the determined photo has the determined sharpness contours with a maximum sharpness score.

In the present invention, upon the user's operation for selecting a position of interest on the cover photo of the photo group, the particular photo with the best sharpness at the point of interest indicated by the user can be determined from the photos successively captured in different focuses. Thus, even though the photos are captured without particularly adjusting the focus of the optical module, the user can find out the photo with the best sharpness at the point of interest in the photo. Hence, the functions of the electronic device for displaying single photo or the photos captured in the multi-focus mode are greatly enhanced and the entertainment for using the electronic device is increased as well.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing an electronic device according to one embodiment of the present invention.

FIG. 2 is a flow chart illustrating a method for successively capturing images of the same scene (or object) in different focuses according to one embodiment of the present invention.

FIG. 3 is a schematic diagram showing photos successively captured in the multi-focus mode according to one embodiment of the present invention.

FIG. 4A is a schematic diagram showing a sharpness look-up table according to one embodiment of the present invention.

FIG. 4B is a schematic diagram showing a sharpness look-up table according to another embodiment of the present invention.

FIG. 4C is a schematic diagram showing a sharpness look-up table according to the other embodiment of the present invention.

FIG. 5 is a flow chart illustrating a displaying method according to one embodiment of the present invention.

FIG. 6A is a flow chart illustrating the steps for determining the photo to be displayed from the photo group based on the scheme of the sharpness look-up table shown in FIG. 4A.

FIG. 6B is a flow chart illustrating the step for determining the photo to be displayed from the photo group based on the scheme of the sharpness look-up table shown in FIG. 4B.

FIG. 6C is a flow chart illustrating the steps for determining the photo to be displayed from the photo group based on the scheme of the sharpness look-up table shown in FIG. 4C.

FIG. 7 is a schematic diagram showing the sharpness contours of the photo according to one embodiment of the present invention.

FIG. 8 is a flow chart showing a displaying method according to one embodiment of the present invention.

FIG. 9A is a schematic diagram showing a cover photo of the photo group according to one embodiment of the present invention.

FIG. 9B is a flow chart illustrating a method

### DESCRIPTION OF THE PREFERRED EMBODIMENTS

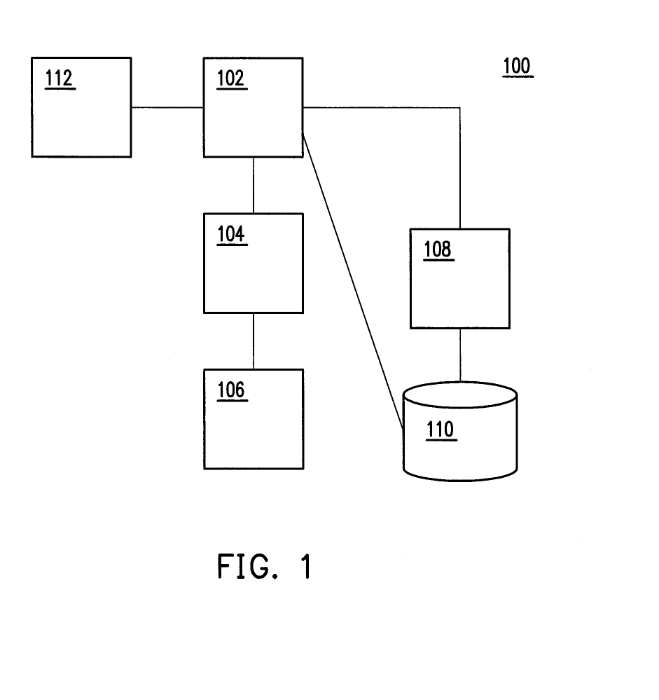

FIG. 1 is a schematic diagram showing an electronic device according to one embodiment of the present invention. As shown in FIG. 1, the electronic device 100 of the present embodiment comprises a processing unit 102, a focus control module 104, an optical module 106, an image capturing module 108, a storage device 110 and a display device 112. The electronic device 100 can be, for example, a personal computer, a tablet personal computer, a smart phone, a personal digital assistant or any electronic device which is capable of displaying photos and even capturing photos.

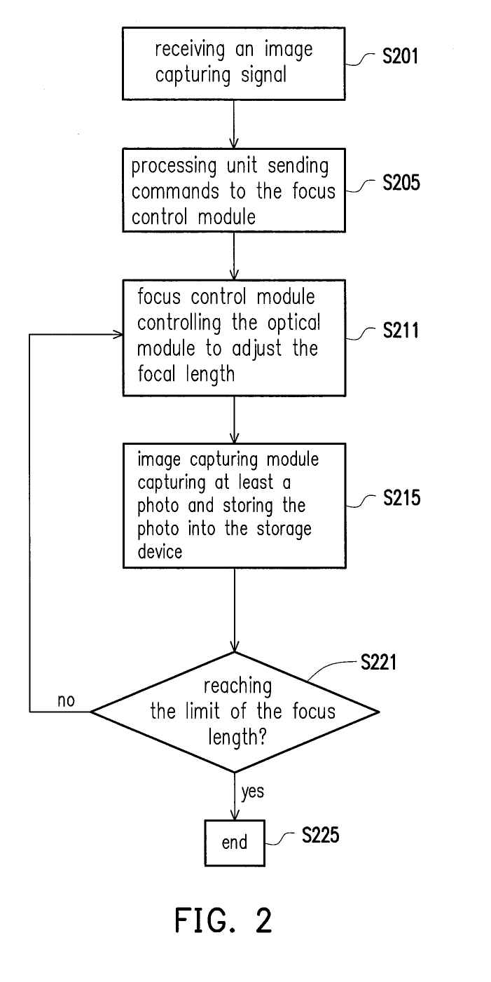

FIG. 2 is a flow chart showing a method for successively capturing images of the same scene (or object) in different focuses according to one embodiment of the present invention. The focuses mentioned herein are defined as the focal length of the optical lenses of the optical module. Specifically, in the present embodiment, the images of the same scene are successively captured by the electronic device in a multi-focus mode in which the focal length of the optical module is changed during the capture of the images. As shown in FIG. 1 and FIG. 2, in the step S201, the processing unit 102 receives an image capturing signal. For instance, the shutter button of the electronic device is pressed by the user to take pictures of the scene/object in multi-focus mode.

In the step S205, the processing unit 102 sends commands to the focus control module 104. In the step S211, upon receiving the commands from the processing unit 102, the focus control module 104 controls the optical module 106 to adjust the focal length. For instance, the optical module 106 adjusts the focal length till the shortest limit of the optical module 106 or the longest limit of the optical module 106. In the step S215, the image capturing module captures at least one photo of the scene/object while the optical module 106 is at the adjusted focal length and stores the photo into the storage device 110. In the step S221, the processing unit 102 checks whether the limit of the focal length of the optical module 106 is reached. If not, the focus control module 104 controls the optical module to adjust the focal length (the step S211) and the image capturing module 108 captures at least one photo of the scene/object and stores the photo into the storage device 110 (the step S215). That is, the steps S211 through S221 are repeated to successively capture photos of the scene/object until the limit of the focal length of the optical module 106 is reached. For instance, if, at the beginning of successively capturing the photos of the scene/object in the multi-focus mode, the focal length of the optical module 106 is adjusted to the shortest limit of the focal length, the focal length of the optical module 106 is gradually increased during the repeat of the steps S211 through S221 until the longest limit of the focal length of the optical module 106 is reached. In other words, during the capture of the photos in the multi-focus mode, the focal length of the optical module 106 is changed from the shortest limit to the longest limit of the optical module 106. Alternatively, if, at the beginning of successively capturing the photos of the scene/object in the multi-focus mode, the focal length of the optical module 106 is adjusted to the longest limit of the focal length, the focal length of the optical module 106 is gradually decreased during the repeat of the steps S211 through S221 until the shortest limit of the focal length of the optical module 106 is reached. In other words, during the capture of the photos in the multi-focus mode, the focal length of the optical module 106 is changed from the longest limit to the shortest limit of the optical module 106. Further, when, in the step S221, it is determined that the limit of the focal length of the optical module 106 is reached, the photo capturing process in the multi-focus mode is ended.

After the photos are successively captured in the multi-focus mode and before the photos are displayed, the photos successively captured in different focuses are respectively analyzed to extract the sharpness information of each of the photos so as to build up a sharpness look-up table and store the sharpness look-up table in the storage device 110. Therefore, the photos successively captured in different focuses under a single image capturing signal are group into a photo group are store in the storage device 110 with the corresponding sharpness look-up table. In the following paragraphs, several embodiments of the sharpness look-up table are illustrated.

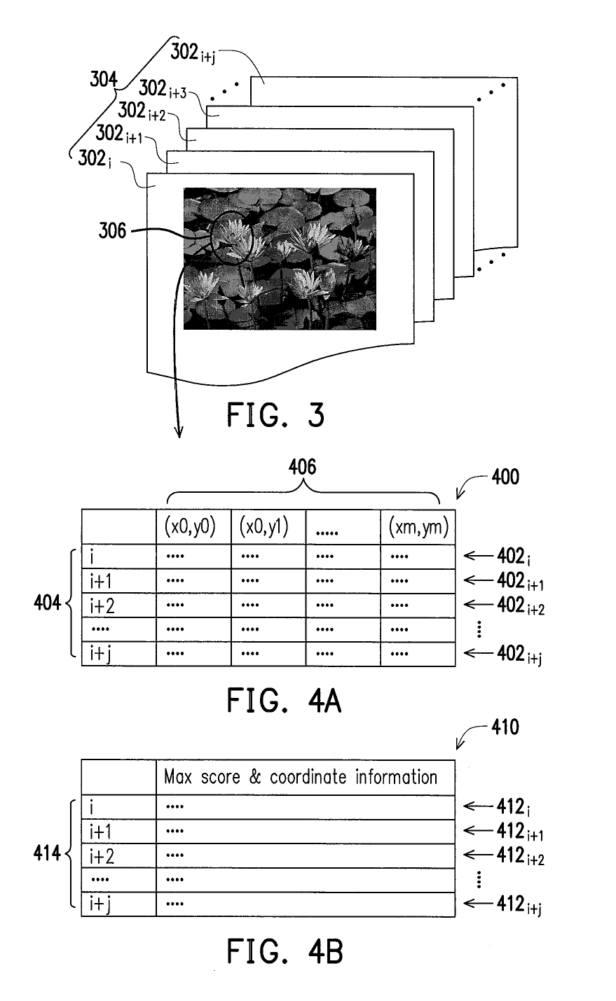

FIG. 3 is a schematic diagram showing photos successively captured in the multi-focus mode according to one embodiment of the present invention. As shown in FIG. 3, the photos 302ᵢ˜302ᵢⱼ which are successively captured in the multi-focus mode are grouped into a photo group 304 and are stored in the storage device 110 (as shown in FIG. 1). For instance, in the storage device 110, the photos 302ᵢ˜302ᵢⱼ in the same photo group 304 are stored under the analogue file names so that the photos 302ᵢ˜302ᵢⱼ belonging to the same photo group 304 can be easily identified.

FIG. 4A is a schematic diagram showing a sharpness look-up table according to one embodiment of the present invention. As shown in FIG. 3 and FIG. 4A, in this embodiment, during the analysis process for extracting the sharpness information of each of the photos 302ᵢ˜302ᵢⱼ, each of the photos 302ᵢ˜302ᵢⱼ is divided into a plurality of sub-images. It should be noticed that each photo in the same photo group 304 is divided into the sub-images by the same divisional method. Further, the divisional method can be varied according to different divisional rules and the divisional method applied onto each photo in the same photo group 304 is not used to limit the scope of the present invention. For instance, each photo in the same photo group 304 can be divided into n×m sub-images, wherein both n and m are natural numbers.

Moreover, for each of the photos 302ᵢ˜302ᵢⱼ, each of the sub-images is analyzed to obtain a corresponding sharpness score. In the present embodiment, a relatively higher sharpness score represents a relatively higher image sharpness. Therefore, in a sharpness look-up table 400 built in this embodiment, the sharpness information (which are labeled 402ᵢ˜402ᵢ₊ⱼ) of the photos 302ᵢ˜302ᵢⱼ are recorded to be respectively corresponding to the identifications 404 (i˜i+j) of the photos and each sharpness information includes the sharpness scores recorded to be respectively corresponding to the sub-images 406. It should be noticed that, in the sharpness look-up table 400 of this embodiment, each sub-image of each of the photos is represented by a coordinate information (such as (x0, y0), (x0, y1) or (xn, ym)) which reflects the coordinate features of the corresponding sub-image on the particular photo.

FIG. 4B is a schematic diagram showing a sharpness look-up table according to another embodiment of the present invention. As shown in FIG. 3 and FIG. 4B, in this embodiment, during the analysis process for extracting the sharpness information of each of the photos 302ᵢ˜302ᵢⱼ, each of the photos 302ᵢ˜302ᵢⱼ is divided into a plurality of sub-images. It should be noticed that, similarly to the previous embodiment, each photo in the same photo group 304 is divided into the sub-images by the same divisional method. Further, the divisional method can be varied according to different divisional rules and the divisional method applied onto each photo in the same photo group 304 is not used to limit the scope of the present invention. For instance, each photo in the same photo group 304 can be divided into n×m sub-images, wherein both n and m are natural numbers.

Moreover, for each of the photos 302ᵢ˜304ᵢⱼ, each of the sub-images is analyzed to obtain a corresponding sharpness score. In the present embodiment, a relatively higher sharpness score represents a relatively higher image sharpness. Therefore, in a sharpness look-up table 410 built in this embodiment, the sharpness information (which are labeled 412ᵢ˜412ᵢ₊ⱼ) of the photos 302ᵢ˜302ᵢⱼ are recorded to be respectively corresponding to the identifications 414 (i˜i+j) of the photos. In addition, for each of the photos 302ᵢ˜302ᵢⱼ, the sharpness information includes a maximum sharpness score among the sharpness scores of the sub-images of the same photo and coordinate information of the sub-image having the maximum sharpness score. It should be noticed that the coordinate information of the sub-image reflects the coordinate features of the corresponding sub-image on a particular photo.

FIG. 4C is a schematic diagram showing a sharpness look-up table according to the other embodiment of the present invention. As shown in FIG. 3 and FIG. 4C, in this embodiment, in the analysis process for extracting the sharpness information of each of the photos, the image data of each photo in the same photo group 304 are analyzed to obtain a plurality of sharpness contours and one sharpness score corresponds to at least one sharpness contour. That is, as shown in FIG. 7 which shows the sharpness contours of the photo according to one embodiment of the present invention, the sharpness/sharpness score along the same sharpness contour (such as the contour 700) in single photo is the same. Further, it is possible that there are to individual sharpness contour correspond to the same sharpness score. Therefore, in the sharpness look-up table 420, the sharpness information (which are labeled 422ᵢ˜422ᵢ₊ⱼ) of the photos 302ᵢ˜302ᵢⱼ are recorded to be respectively corresponding to the identifications 424 (i˜i+j) of the photos. Moreover, for each of the photos 302ᵢ˜302ᵢⱼ, the sharpness information includes a plurality of coordinate sets respectively corresponding to the sharpness contours of the photo and the sharpness scores respectively corresponding to the coordinate sets. For instance, as shown in the field 424 of “Sharpness score of sharpness contour Fx1 & coordinate set” of the photo with the identification i, the sharpness score of the sharpness contour Fx1 is labeled “S1” and the coordinate set of the sharpness contour Fx1 is labeled “{ (x1c1,y1c1) . . . (x1cr, y1cw)}”.

In the following paragraphs, a displaying method of the present invention is illustrated accompanied with drawings. The displaying method of the present invention is adopted by the electronic device for displaying one of the photos successively captured in different focuses and belonging to the same photo group and the displayed photo possesses the best sharpness at the particular position indicated by the user. The electronic device and components (such as the storage device and the sharpness look-up table stored in the storage device) of the electronic device are detailed in the previous embodiment shown in FIG. 1 and are not further described in the following embodiments.

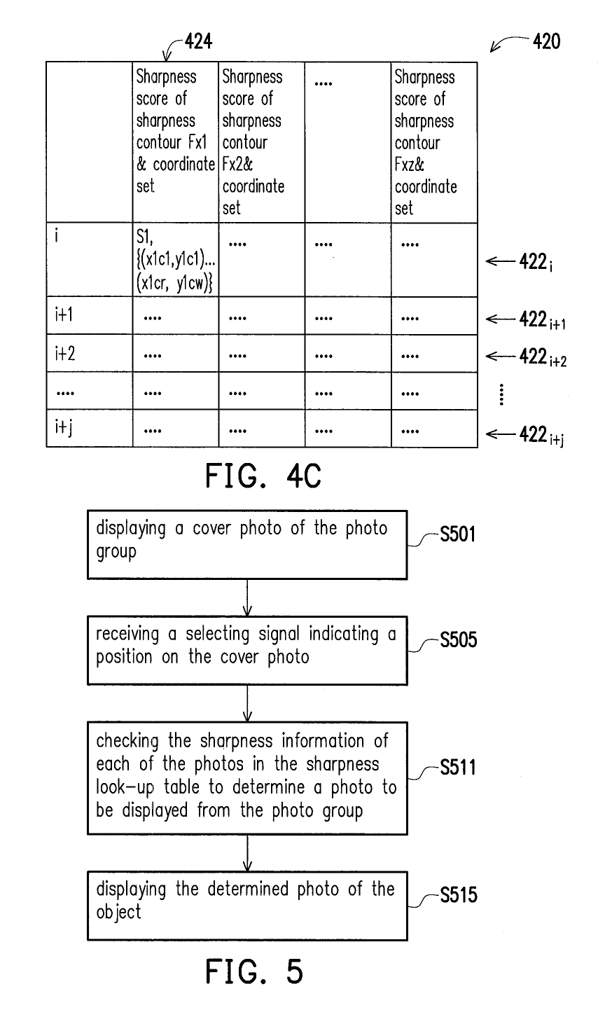

FIG. 5 is a flow chart showing a displaying method according to one embodiment of the present invention. As shown in FIG. 1 and FIG. 5, in the step S501, the process unit 102 of the electronic device 100 controls the display device 112 to display a cover photo of the photo group. It should be noticed that the cover photo or best focus photo of the photo group can be, for example, random picked photo from the photo group or a middle photo in the serial photos of the photo group. In the step S505, the processing unit 102 receives a selecting signal indicating a position of interest on the cover photo. For instance, the user can use the mouse to indicate an area/position of interest on the cover photo. Furthermore, when the display device 112 is a touch screen, the user can, for example, directly use an input device (such as a finger or a stylus) to touch the display device displaying the cover photo and the contact point on the display device corresponds to the area/position of interest on the cover photo.

In the step S511, according to the position, the processing unit 102 checks the sharpness information of each of the photos in the sharpness look-up table to determine a photo to be displayed from the photo group. It should be noticed that the sharpness information of the determined photo reveals that the sharpness score at the position of the determined photo is the maximum among the sharpness scores at the positions of the photos in the photo group. In the step S515, the processing unit 102 controls the display device 112 to display the determined photo of the object. Therefore, the final displayed photo possesses the highest sharpness score at the point indicated by the selecting signal. In other words, the final displayed photo possesses the best sharpness at the position indicated by the user.

Moreover, the methods for determining the photo to be displayed from the photo group according to the sharpness information of each of the photos in the sharpness look-up table (step S511) are different based on different schemes of the sharpness look-up tables mentioned in the previous embodiments. In the following paragraphs, several embodiments of the aforementioned step S511 are illustrated.

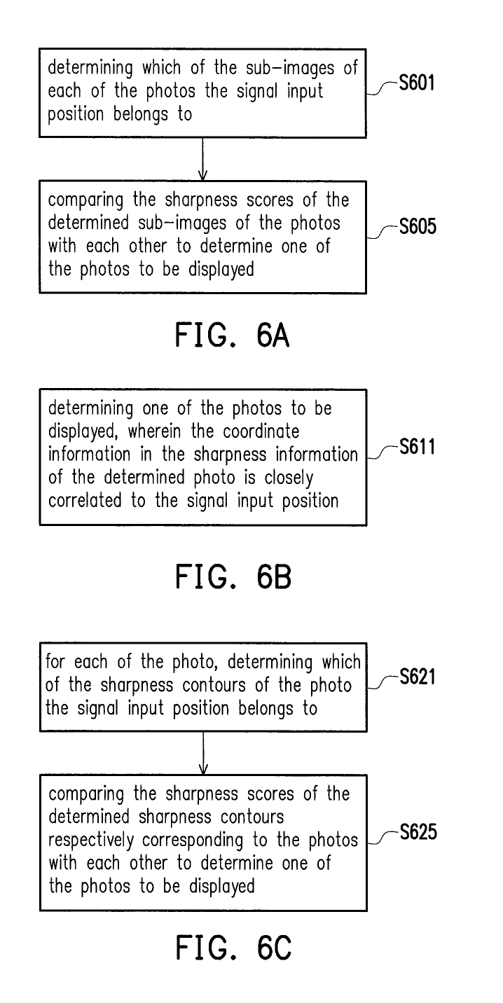

FIG. 6A is a flow chart showing the steps for determining the photo to be displayed from the photo group based on the scheme of the sharpness look-up table shown in FIG. 4A. As shown in FIG. 3, FIG. 4A and FIG. 6A, when the selecting signal indicating the position 306 of interest in the cover photo 302ᵢ, in the step S601, for each of the photos in the same photo group, the processing unit 102 determines which of the sub-images the position 306 belongs to according to the sharpness look-up table 400. Then, in the step S605, the processing unit 102 compares the sharpness scores of the determined sub-images of the photos with each other to determine one of the photos to be displayed. It should be noticed that the determined photo has the determined sub-image with a maximum sharpness score. That is, in the determined photo, the sub-image in which the point indicated by the user is located has the best sharpness.

FIG. 6B is a flow chart showing the steps for determining the photo to be displayed from the photo group based on the scheme of the sharpness look-up table shown in FIG. 4B. As shown in FIG. 3, FIG. 4B and FIG. 6B, when the selecting signal indicating the position 306 of interest in the cover photo 302ᵢ, in the step S611, according to the coordinate information of each of the photos in the sharpness look-up table 410, the processing unit 102 determines one of the photos to be displayed, wherein the coordinate information in the sharpness information of the determined photo is closely correlated to the position 306. That is, by checking the coordinate information of each sharpness information in the sharpness look-up table 410, at least one of the photos having the corresponding coordinate information closely correlated to the position can be determined to be displayed. In other words, from the coordinate information of the sub-image of the photo determined to be displayed, it shows that the position 306 of interest is within the sub-image of the photo determined to be displayed. Moreover, if there are more than one photos having the corresponding coordinate information closely correlated to the position, the one with the highest sharpness score at the position is determined to be displayed.

FIG. 6C is a flow chart showing the steps for determining the photo to be displayed from the photo group based on the scheme of the sharpness look-up table shown in FIG. 4C. As shown in FIG. 3, FIG. 4C and FIG. 6C, when the selecting signal indicating the position 306 of interest in the cover photo 302ᵢ, in the step S621, for each of the photos, the processing unit 102 determines which of the sharpness contours of the photo the position 306 belongs to according to the sharpness look-up table 420. Then, in the step S625, the processing unit 102 compares the sharpness scores of the determined sharpness contours respectively corresponding to the photos with each other so as to determine one of the photos to be displayed. It should be noticed that the determined photo has the determined sharpness contours with a maximum sharpness score.

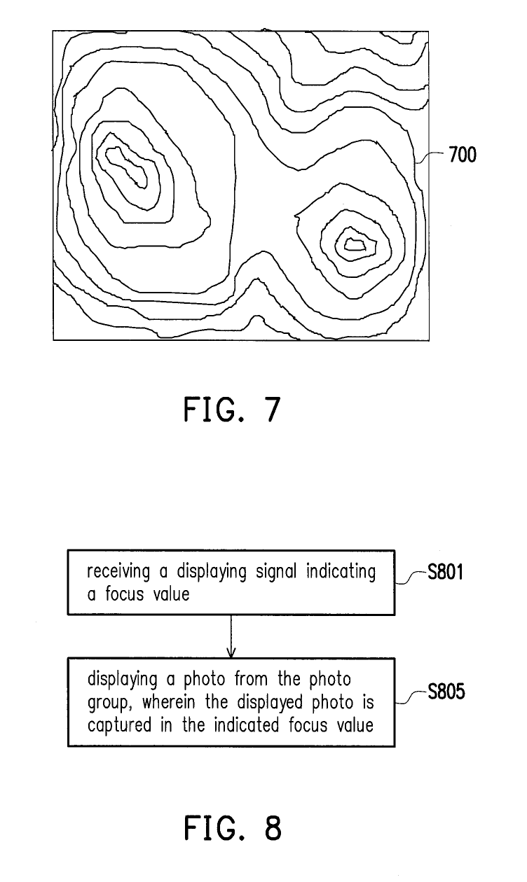

Except for the aforementioned displaying method for displaying one photo with the best sharpness at the user's position of interest thereon, the present invention further provides a displaying method for displaying the photos in the same photo group according to the user's operation. FIG. 8 is a flow chart showing a displaying method according to one embodiment of the present invention. As shown in FIG. 8, in the step S801, the processing unit 102 (as shown in FIG. 1) receives a displaying signal indicating a focus value and, in the step S805, the processing unit 102 controls the display device to display a photo from the photo group 304 (as shown in FIG. 3), wherein the displayed photo is captured in the indicated focus value.

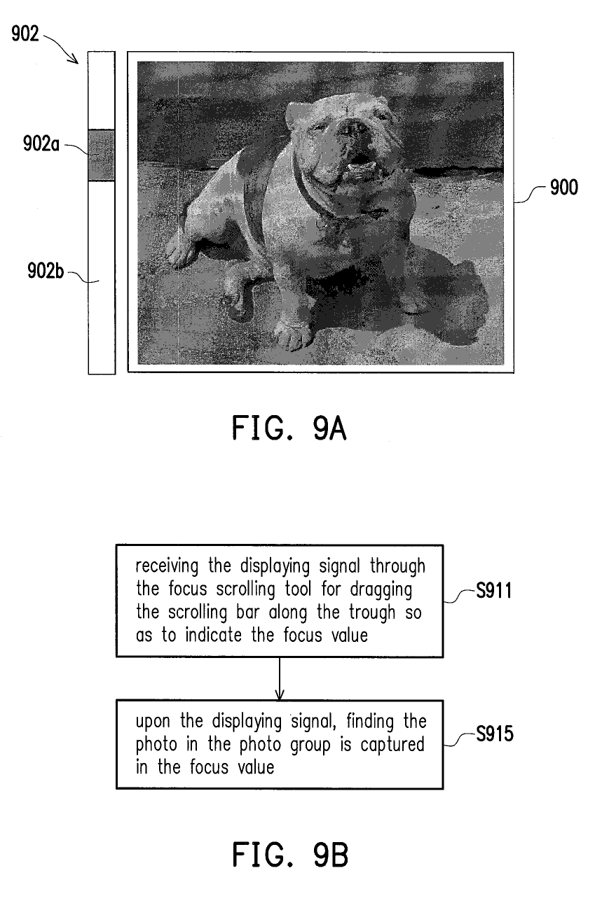

More specifically, as shown in FIG. 9A which shows a cover photo of the photo group according to one embodiment of the present invention, the cover photo 900 is displayed with a focus scrolling tool 902 having a scrolling bar 902a and a trough 902b which the scrolling bar 902a moves along. In this embodiment, the processing unit 102 of the electronic device 100 receives the displaying signal through the focus scrolling tool for dragging the scrolling bar along the trough so as to indicate the focus value of the photo to be displayed (step S911 shown in FIG. 9B). Then, upon the displaying signal, the processing unit 102 finds the adequate photo from the photo group which is captured in the focus value (step S915 shown in FIG. 9B).

In the present invention, upon the user's operation for selecting a position of interest on the cover photo of the photo group, the particular photo with the best sharpness at the point of interest indicated by the user can be determined from the photos successively captured in different focuses. Thus, even though the photos are captured without particularly adjusting the focus of the optical module, the user can find out the photo with the best sharpness at the point of interest in the photo. Hence, the functions of the electronic device for displaying single photo or the photos captured in the multi-focus mode are greatly enhanced and the entertainment for using the electronic device is increased as well.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A displaying method for an electronic device, wherein the electronic device comprises a storage device storing at least a photo group, the photo group includes a plurality of photos of an object captured in different focuses, the displaying method comprising:
displaying a photo of the photo group;
receiving a selecting signal indicating a position on the photo;
according to the position, checking sharpness information of each of the photos to determine a photo to be displayed from the photo group; and
displaying the determined photo of the object.

2. The displaying method of claim 1, wherein, the electronic device comprises a storage device storing a sharpness look-up table.

3. The displaying method of claim 2, wherein, according to the position, checking sharpness information of each of the photos in the sharpness look-up table to determine a photo to be displayed from the photo group,

4. The displaying method of claim 3, wherein, for each of the photos, the photo is divided into a plurality of sub-images respectively corresponding to the sharpness scores and, in the sharpness look-up table, the sharpness information of each of the photos includes the sharpness scores respectively with the corresponding the sub-images.

5. The displaying method of claim 3, wherein the step of checking the sharpness information of each of the photos comprises:
for each of the photos, determining which of the sub-images the position belongs to; and
comparing the sharpness scores of the determined sub-images of the photos with each other to determine one of the photos to be displayed, wherein the determined photo has the determined sub-image with a maximum sharpness score.

6. The displaying method of claim 1, wherein, for each of the photos, the photo is divided into a plurality of sub-images respectively corresponding to the sharpness scores and, in the sharpness look-up table, the sharpness information of each of the photos includes a maximum sharpness score among the sharpness scores of the sub-images and coordinate information of the sub-image having the maximum sharpness score.

7. The displaying method of claim 6, wherein the step of checking the sharpness information of each of the photos comprises:
according to the coordinate information of each of the photos in the sharpness look-up table, determining one of the photos to be displayed, wherein the coordinate information in the sharpness information of the determined photo is closely correlated to the position.

8. The displaying method of claim 1, wherein, in the sharpness look-up table, the sharpness information of each of the photos includes a plurality of coordinate sets respectively corresponding to a plurality of sharpness contours of the photo and the sharpness scores respectively corresponding to the coordinate sets.

9. The displaying method of claim 8, wherein the step of checking the sharpness information of each of the photos comprises:
for each of the photos, determining which of the sharpness contours of the photo the position belongs to; and
comparing the sharpness scores of the determined sharpness contours respectively corresponding to the photos with each other to determine one of the photos to be displayed, wherein the determined photo has the determined sharpness contours with a maximum sharpness score.

10. The displaying method of claim 1, wherein the cover photo of the photo group is random picked.

11. The displaying method of claim 1, wherein, before the step of displaying the cover photo of the photo group, the photos successively captured in different focuses are analyzed to extract the sharpness information of each of the photos so as to build up the sharpness look-up table and the sharpness look-up table is stored in the storage device with the photo group.

12. An electronic device, comprising:
a storage device, storing at least a photo group and a look-up table, wherein the photo group includes a plurality of photos of an object captured in different focuses, and the look-up table records sharpness information of each of the photos; and
a processing unit, receiving a selecting signal indicating a position on the photo, checking the sharpness information of each of the photos in the look-up according to the position to determine a photo to be displayed from the photo group.

13. The electronic device of claim 12, wherein for each of the photos, the photo is divided into a plurality of sub-images respectively corresponding to the sharpness scores and, in the sharpness look-up table, the sharpness information of each of the photos includes the sharpness scores respectively with the corresponding the sub-images.

14. The electronic device of claim 13, wherein the processing unit checking the sharpness information of each of the photos further comprises:
for each of the photos, determining which of the sub-images the position belongs to; and
comparing the sharpness scores of the determined sub-images of the photos with each other to determine one of the photos to be displayed, wherein the determined photo has the determined sub-image with a maximum sharpness score.

15. The electronic device of claim 12, wherein, for each of the photos, the photo is divided into a plurality of sub-images respectively corresponding to the sharpness scores and, in the sharpness look-up table, the sharpness information of each of the photos includes a maximum sharpness score among the sharpness scores of the sub-images and coordinate information of the sub-image having the maximum sharpness score.

16. The electronic device of claim 15, wherein the processing unit checking the sharpness information of each of the photos further comprises:
according to the coordinate information of each of the photos in the sharpness look-up table, determining one of the photos to be displayed, wherein the coordinate information in the sharpness information of the determined photo is closely correlated to the position.

17. The electronic device of claim 12, wherein, in the sharpness look-up table, the sharpness information of each of the photos includes a plurality of coordinate sets respectively corresponding to a plurality of sharpness contours of the photo and the sharpness scores respectively corresponding to the coordinate sets.

18. The electronic device of claim 17, wherein the processing unit checking the sharpness information of each of the photos further comprises:
for each of the photo, determining which of the sharpness contours of the photo the position belongs to; and
comparing the sharpness scores of the determined sharpness contours respectively corresponding to the photos with each other to determine one of the photos to be displayed, wherein the determined photo has the determined sharpness contours with a maximum sharpness score.
